(19) United States
(12) Patent Application Publication
(10) Pub. No.: US 2017/0083336 A1
(43) Pub. Date: Mar. 23, 2017

(54) PROCESSOR EQUIPPED WITH HYBRID CORE ARCHITECTURE, AND ASSOCIATED METHOD

(71) Applicant: MEDIATEK INC., Hsin-Chu (TW)

(72) Inventor: Chia-Lin Lu, Kaohsiung City (TW)

(21) Appl. No.: 14/863,439

(22) Filed: Sep. 23, 2015

(51) Int. Cl. G06F 9/30; G06F 12/08; G06F 9/38

(52) U.S. Cl. CPC G06F 9/30189; G06F 9/3808; G06F 9/3804; G06F 9/3822; G06F 9/3867; G06F 9/30043; G06F 9/30047; G06F 12/0833; G06F 12/0806; G06F 2212/621

(57) ABSTRACT

A processor equipped with hybrid core architecture and an associated method are provided, where the processor includes a hybrid core that is configurable into different arrangements in different modes of the hybrid core, respectively, and the different arrangements includes a first arrangement and a second arrangement. The first arrangement in a first mode of the hybrid core causes the hybrid core to act as a first core, and the first core corresponding to the first arrangement is arranged for reading and executing program instructions for the processor. The second arrangement in a second mode of the hybrid core causes the hybrid core to act as a second core, and the second core corresponding to the second arrangement is arranged for reading and executing program instructions for the processor. The second core corresponding to the second arrangement shares a portion of circuits of the first core corresponding to the first arrangement.

### BACKGROUND

The present invention relates to architecture of a processor such as a processing unit apparatus (e.g. a central processing unit (CPU), a graphics processing unit (GPU), or the like), and more particularly, to a processor equipped with a hybrid core architecture, and an associated method.

A conventional electronic device such as a conventional mobile phone may have a processor (e.g. a CPU) to control operations of the conventional electronic device. During implementing the conventional electronic device, there is typically a tradeoff between using a conventional high performance CPU (e.g. a high end CPU) and using a conventional low power CPU (e.g. a low end CPU , since the conventional high performance CPU usually consumes more power than the conventional low power CPU and the conventional low power CPU usually has lower performance than the conventional high performance CPU. According to the related art, a multi-cluster heterogeneous architecture having a cache snooping channel (e.g. those having the so-called Cache Coherent Interconnect (CCI) such as CCI-400 in the related art) is proposed, and may be helpful on solving this problem. However, further problems such as some side effects may be introduced. For example, implementing the cache snooping channel mentioned above may cause the related costs to be increased. In another example, when implementing the cache snooping channel mentioned above, the circuitry of the processor may become complicated, which may cause wire congestion. Thus, a novel architecture is required for enhancing the overall performance of an electronic device with fewer side effects.

### SUMMARY

It is therefore an objective of the claimed invention to provide a processor equipped with a hybrid core architecture, and an associated method, in order to solve the above-mentioned problems.

It is another objective of the claimed invention to provide a processor equipped with a hybrid core architecture, and an associated method, in order to enhance the overall performance of the electronic device comprising the processor with fewer side effects.

According to at least one preferred embodiment, a processor is provided, where the processor comprises a hybrid core that is configurable into different arrangements in different modes of the hybrid core, respectively, and the different arrangements may comprise a first arrangement and a second arrangement. For example, the first arrangement in a first mode of the hybrid core may cause the hybrid core to act as a first core, and the first core corresponding to the first arrangement is arranged for reading and executing program instructions for the processor. In another example, the second arrangement in a second mode of the hybrid core may cause the hybrid core to act as a second core, and the second core corresponding to the second arrangement is arranged for reading and executing program instructions for the processor. In addition, the second core corresponding to the second arrangement shares a portion of circuits of the first core corresponding to the first arrangement. More particularly, the whole of the second core corresponding to the second arrangement is within the first core corresponding to the first arrangement.

According to at least one preferred embodiment, a method for performing operational mode control on a processor is also provided, where the method comprises the steps of: detecting whether a trigger event occurs to generate a detecting result, for controlling a hybrid core of the processor, wherein the hybrid core is configurable into different arrangements in different modes of the hybrid core, respectively, and the different arrangements of the hybrid core may comprise a first arrangement and a second arrangement; and according to the detecting result, performing mode switching of the hybrid core to configure the hybrid core into a specific arrangement within the different arrangements. For example, the first arrangement in a first mode of the hybrid core may cause the hybrid core to act as a first core, and the first core corresponding to the first arrangement is arranged for reading and executing program instructions for the processor. In another example, the second arrangement in a second mode of the hybrid core may cause the hybrid core to act as a second core, and the second core corresponding to the second arrangement is arranged for reading and executing program instructions for the processor. In addition, the second core corresponding to the second arrangement shares a portion of circuits of the first core corresponding to the first arrangement.

It is an advantage of the present invention that the present invention processor and the associated method can enhance the overall performance of the electronic device comprising the processor with fewer side effects, where the present invention processor and the associated method can reduce power consumption of the electronic device, and therefore the user of the electronic device can utilize the electronic device for a long time between two battery charging operations. In addition, in comparison with the related art, the present invention hybrid core architecture can reduce the circuitry complexity and the chip area. As the hybrid core architecture may have reused hardware resources (e.g. caches, some pipeline stages, etc.) and no snooping-channel is required, and as wire congestion can be prevented, the goals of reducing the related costs, reducing the power consumption, and heat reduction can be achieved.

Additionally, by implementing according to one or more embodiments of the present invention, a same cluster may own heterogeneous cores, so it is unnecessary to use a snooping channel for maintaining coherence, where the snooping channel is typically used for snooping between different clusters. As a result, when performing mode switching, only flushing the internal pipeline is needed. Therefore, in comparison with the related art, the present invention processor can reduce penalty of code migration between different modes, and can easily perform mode switching by just flushing the internal pipeline thereof and then switching to a target mode (e.g. the first mode, or the second mode) , and can further provide more various combinations of hybrid core configurations since one hybrid core in the present invention processor (such as the hybrid core mentioned above, the specific hybrid core mentioned above, or any hybrid core within the plurality of hybrid cores mentioned above) can be configured to be any core within two or more pre-defined cores. For example, the hybrid core can act as a big core, a small core or even turned off. Assuming a processor includes four hybrid cores, examples of the aforementioned various combinations of hybrid core configurations may include, but not limited to, one small core, two small cores, three small cores, four small cores, one big core, two big cores, three big cores, four big cores, one big core plus one or more small cores, two big cores plus one or more small cores, three big cores plus one small core, etc.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a processor equipped with a hybrid core architecture according to an embodiment of the present invention.

FIG. 2 illustrates a flowchart of a method for performing operational mode control on a processor according to an embodiment of the present invention.

FIG. 3 illustrates a processor pipeline involved with the method shown in FIG. 2 according to an embodiment of the present invention.

FIG. 4 illustrates some processor pipelines involved with the method shown in FIG. 2 according to an embodiment of the present invention.

FIG. 5 illustrates some pipeline stages involved with the method shown in FIG. 2 according to an embodiment of the present invention.

FIG. 6 is a diagram of a processor equipped with a hybrid core architecture according to another embodiment of the present invention, where there are four hybrid cores in the cluster shown in FIG. 6.

FIG. 7 is a diagram of a processor equipped with a hybrid core architecture according to another embodiment of the present invention, where there are four hybrid cores in the cluster shown in the left half of FIG. 7.

FIG. 8 illustrates a working flow involved with the method shown in FIG. 2 according to an embodiment of the present invention.

FIG. 9 illustrates a working flow involved with the method shown in FIG. 2 according to another embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

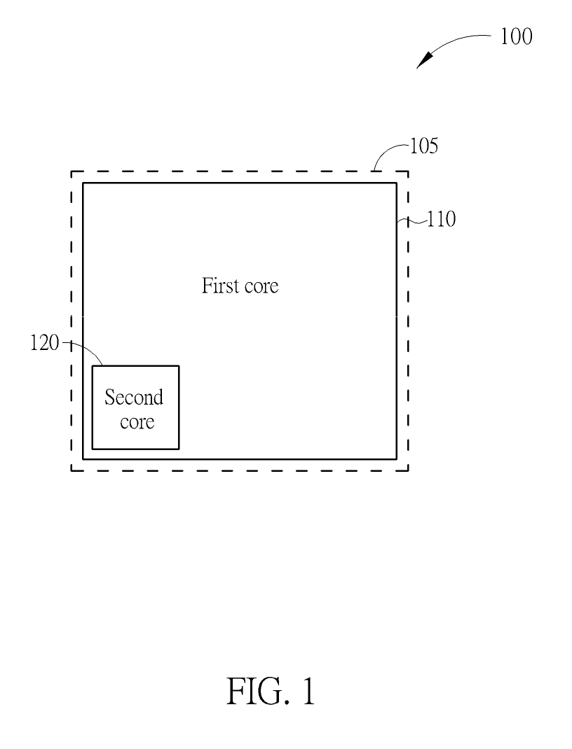

FIG. 1 is a diagram of a processor 100 equipped with a hybrid core architecture according to an embodiment of the present invention. For example, the processor 100 may comprise at least one hybrid core (e.g. one or more hybrid cores) such as a hybrid core 105. As shown in FIG. 1, the hybrid core 105 is configurable into different arrangements indifferent modes of the hybrid core 105, respectively, where the aforementioned different arrangements may comprise a first arrangement and a second arrangement. For example, the first arrangement in a first mode of the hybrid core 105 may cause the hybrid core 105 to act as a first core 110 (e.g. a big core), and the first core 110 corresponding to the first arrangement is arranged for reading and executing program instructions for the processor 100. In another example, the second arrangement in a second mode of the hybrid core 105 may cause the hybrid core 105 to act as a second core 120 (e.g. a small core), and the second core 120 corresponding to the second arrangement is arranged for reading and executing program instructions for the processor 100. In addition, the second core 120 corresponding to the second arrangement may share a portion of circuits of the first core 110 corresponding to the first arrangement. In one example, the whole of the second core 120 corresponding to the second arrangement is within the first core 110 corresponding to the first arrangement, where the second core 120 is smaller than the first core 110.

In practice, the processor 100 can be implemented to be a central processing unit (CPU) . This is for illustrative purposes only, and is not meant to be a limitation of the present invention. According to some embodiments of the present invention, the processor 100 can be implemented to be a graphics processing unit (GPU). According to some embodiments of the present invention, the processor 100 may comprise a combination of a CPU and a GPU such as a CPU and a GPU that are integrated into the processor 100.

In addition, the first core 110 corresponding to the first arrangement may comprise a plurality of pipeline stages, where the second core 120 corresponding to the second arrangement may share at least one processing circuit in a pipeline stage within the plurality of pipeline stages of the first core 110 corresponding to the first arrangement. This is for illustrative purposes only, and is not meant to be a limitation of the present invention.

According to some embodiments of the present invention, the first core 110 corresponding to the first arrangement may comprise a plurality of pipeline stages such as that mentioned above. For example, a specific pipeline stage within the plurality of pipeline stages may comprise a plurality of processing circuits arranged for performing processing in parallel for the first core 110 corresponding to the first arrangement, where the second core 120 corresponding to the second arrangement may share a specific processing circuit within the plurality of processing circuits. More particularly, the specific pipeline stage can be an out-of-order execution pipeline stage within the first core 110 corresponding to the first arrangement, and the specific processing circuit may become a processing circuit of an in-order execution pipeline stage within the second core 120 corresponding to the second arrangement when the hybrid core 105 acts as the second core 120.

According to a portion of embodiments within these embodiments, another pipeline stage within the plurality of pipeline stages may comprise a plurality of other processing circuits, and the second core 120 corresponding to the second arrangement may share at least one processing circuit within the plurality of other processing circuits. In one embodiment, the other pipeline stage can be an in-order decode pipeline stage within the first core 110 corresponding to the first arrangement, and the aforementioned at least one processing circuit within the plurality of other processing circuits may become at least one processing circuit of an in-order decode pipeline stage within the second core 120 corresponding to the second arrangement when the hybrid core 105 acts as the second core 120. For example, the plurality of other processing circuits may comprise a plurality of instruction fetch circuits. In another example, the plurality of other processing circuits may comprise a plurality of instruction decode circuits. This is for illustrative purposes only, and is not meant to be a limitation of the present invention. According to another portion of these embodiments, the other pipeline stage can be an in-order commit pipeline stage within the first core 110 corresponding to the first arrangement, and the aforementioned at least one processing circuit within the plurality of other processing circuits may become at least one processing circuit of an in-order commit pipeline stage within the second core 120 corresponding to the second arrangement when the hybrid core 105 acts as the second core 120.

According to some embodiments of the present invention, the portion of circuits of the first core 110 corresponding to the first arrangement (i.e. the portion shared with the second core corresponding to the second arrangement) can be turned on in each mode of the first mode and the second mode. In one example, another portion of circuits of the first core 110 corresponding to the first arrangement can be turned off in the second mode. In another example, both of the portion of circuits of the first core 110 corresponding to the first arrangement (i.e. the portion shared with the second core corresponding to the second arrangement) and the other portion of circuits of the first core 110 corresponding to the first arrangement can be turned on in the first mode. This is for illustrative purposes only, and is not meant to be a limitation of the present invention. In some examples, the first core 110 corresponding to the first arrangement can include both of the portion of circuits of the first core 110 corresponding to the first arrangement (i.e. the portion shared with the second core corresponding to the second arrangement) and the other portion of circuits of the first core 110 corresponding to the first arrangement. In some examples, the aforementioned different arrangements of the hybrid core 105 may comprise more than two arrangements. For example, the hybrid core 105 may be configurable into a third arrangement of the hybrid core 105 in a third mode of the hybrid core 105. The third arrangement of the hybrid core 105 may cause the hybrid core 105 to act as a third core (e.g. a middle core), and the third core corresponding to the third arrangement of the hybrid core 105 is arranged for reading and executing program instructions for the processor 100.

According to some embodiments of the present invention, the processor 100 may comprise a plurality of hybrid cores, and the hybrid core 105 can be a specific hybrid core within the plurality of hybrid cores, where another hybrid core within the plurality of hybrid cores is configurable into different arrangements of the other hybrid core in different modes of the other hybrid core, respectively. In one embodiment, any two hybrid cores within the plurality of hybrid cores can be equivalent to each other. This is for illustrative purposes only, and is not meant to be a limitation of the present invention. In one embodiment, the aforementioned different arrangements of the other hybrid core may comprise a third arrangement of the other hybrid core and a fourth arrangement of the other hybrid core. For example, the third arrangement of the other hybrid core in a third mode of the other hybrid core may cause the other hybrid core to act as a third core (e.g. a big core) corresponding to the third arrangement of the other hybrid core, and the third core corresponding to the third arrangement of the other hybrid core is arranged for reading and executing program instructions for the processor 100. In another example, the fourth arrangement of the other hybrid core in a fourth mode of the other hybrid core may cause the other hybrid core to act as a fourth core (e.g. a small core) corresponding to the fourth arrangement of the other hybrid core, and the fourth core corresponding to the fourth arrangement of the other hybrid core is arranged for reading and executing program instructions for the processor 100. In addition, the fourth core corresponding to the fourth arrangement of the other hybrid core may share a portion of circuits of the third core corresponding to the third arrangement of the other hybrid core. In one example, the whole of the fourth core corresponding to the fourth arrangement of the other hybrid core is within the third core corresponding to the third arrangement of the other hybrid core, where the fourth core corresponding to the fourth arrangement of the other hybrid core is smaller than the third core corresponding to the third arrangement of the other hybrid core.

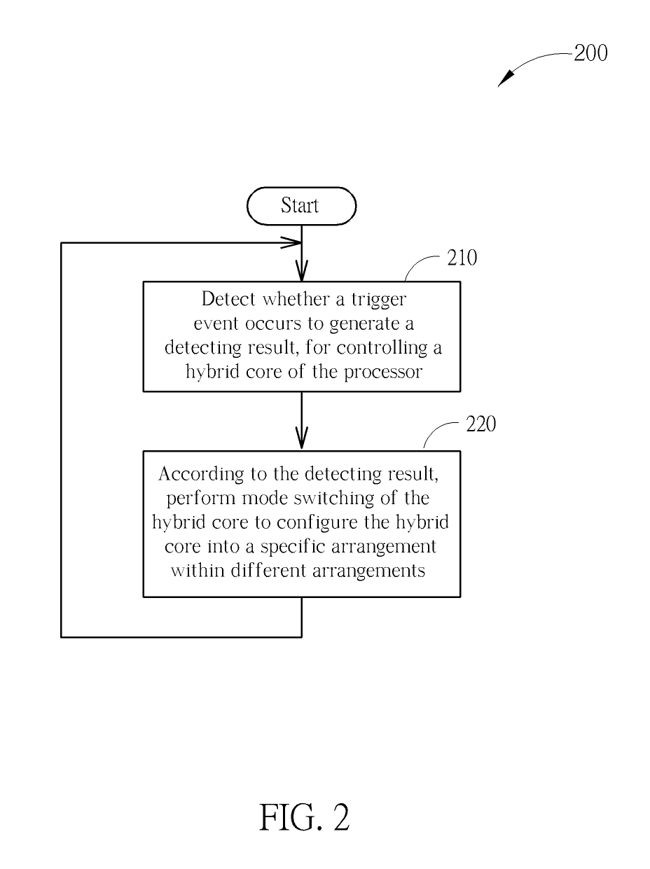

FIG. 2 illustrates a flowchart of a method 200 for performing operational mode control on a processor such as the processor 100 shown in FIG. 1 according to an embodiment of the present invention. The method 200 shown in FIG. 2 can be applied to any processor equipped with the hybrid core architecture mentioned above, such as the processor 100 shown in FIG. 1. In one example, one or more operations of the method 200 can be performed by a processor core running program code(s) associated to the method 200, where the processor core can be a core that is currently active within the processor 100. This is for illustrative purposes only, and is not meant to be a limitation of the present invention. The method 200 can be described as follows.

In Step 210, the processor 100 may detect whether a trigger event occurs to generate a detecting results, for controlling a hybrid core of the processor 100 (e.g. the hybrid core 105 of the processor 100, or the other hybrid core mentioned in some embodiments described between the embodiment shown in FIG. 1 and the embodiment shown in FIG. 2), where the hybrid core mentioned in Step 210 (e.g. the hybrid core 105, or the other hybrid core mentioned above) is configurable into different arrangements in different modes of this hybrid core, respectively.

In one embodiment, the different arrangements of the hybrid core may comprise a first arrangement such as that mentioned above, and may further comprise a second arrangement such as that mentioned above. For example, the first arrangement in a first mode of the hybrid core (e.g. the aforementioned first arrangement in the aforementioned first mode of the hybrid core mentioned in the embodiment shown in FIG. 1) may cause the hybrid core to act as a first core such as the first core 110 (e.g. a big core), and the first core 110 corresponding to the first arrangement is arranged for reading and executing program instructions for the processor 100. In another example, the second arrangement in a second mode of the hybrid core (e.g. the aforementioned second arrangement in the aforementioned second mode of the hybrid core mentioned in the embodiment shown in FIG. 1) may cause the hybrid core to act as a second core such as the second core 120 (e.g. a small core), and the second core 120 corresponding to the second arrangement is arranged for reading and executing program instructions for the processor 100. Please note that the second core 120 corresponding to the second arrangement may share the aforementioned portion of circuits of the first core 110 corresponding to the first arrangement. In one example, the whole of the second core 120 corresponding to the second arrangement is within the first core 110 corresponding to the first arrangement, where the second core 120 is smaller than the first core 110.

In Step 220, according to the detecting result, the processor 100 may perform mode switching of the hybrid core mentioned in Step 210 (e.g. the hybrid core 105, or the other hybrid core mentioned in some embodiments described between the embodiment shown in FIG. 1 and the embodiment shown in FIG. 2) to configure the hybrid core into a specific arrangement within the different arrangements.

For example, the trigger event mentioned in Step 210 may indicate that the computing capability of the processor 100 is insufficient (e.g. the computing capability of the processor 100 is insufficient at the moment when the occurrence of the trigger event mentioned in Step 210 is detected). In one example, in Step 220, in a situation where the hybrid core mentioned in Step 210 is in the second mode, the processor 100 may perform mode switching of the hybrid core to switch to the first mode, to configure the hybrid core into the first arrangement. This is for illustrative purposes only, and is not meant to be a limitation of the present invention. According to some embodiments, in a situation where the number of cores within the processor 100 is greater than one, the processor 100 may turn on another core (e.g. another hybrid core or a normal core) within the cores of the processor 100, where the hybrid core mentioned in Step 210 can be temporarily kept in the second mode mentioned above. According to some embodiments, in a situation where the number of cores within the processor 100 is greater than one, the processor 100 may perform mode switching of another core (e.g. another hybrid core) within the processor 100, where the hybrid core mentioned in Step 210 can be temporarily kept in the second mode mentioned above.

In another example, the trigger event mentioned in Step 210 may indicate that the computing capability of the processor 100 is insufficient (e.g. the computing capability of the processor 100 is insufficient at the moment when the occurrence of the trigger event mentioned in Step 210 is detected). In one example, in Step 220, in a situation where the hybrid core mentioned in Step 210 is in a turned off mode, the processor 100 may perform mode switching of the hybrid core to switch to the second mode, to configure the hybrid core into the second arrangement. This is for illustrative purposes only, and is not meant to be a limitation of the present invention. According to some embodiments, in a situation where the number of cores within the processor 100 is greater than one, the processor 100 may turn on another core (e.g. another hybrid core or a normal core) within the cores of the processor 100, where the hybrid core mentioned in Step 210 can be temporarily kept in the turned off mode mentioned above. According to some embodiments, in a situation where the number of cores within the processor 100 is greater than one, the processor 100 may perform mode switching of another core (e.g. another hybrid core) within the processor 100, where the hybrid core mentioned in Step 210 can be temporarily kept in the turned off mode mentioned above.

In another example, the trigger event mentioned in Step 210 may indicate that at least one portion of the processor 100 is idle (e.g. the aforementioned at least one portion of the processor 100 is idle at the moment when the occurrence of the trigger event mentioned in Step 210 is detected). In one example, in Step 220, in a situation where the hybrid core is in the first mode, the processor 100 may perform mode switching of the hybrid core to switch to the second mode, to configure the hybrid core into the second arrangement. This is for illustrative purposes only, and is not meant to be a limitation of the present invention. According to some embodiments, in a situation where the number of cores within the processor 100 is greater than one, the processor 100 may turn off another core (e.g. another hybrid core or a normal core) within the cores of the processor 100, where the hybrid core mentioned in Step 210 can be temporarily kept in the first mode mentioned above. According to some embodiments, in a situation where the number of cores within the processor 100 is greater than one, the processor 100 may perform mode switching of another core (e.g. another hybrid core) within the processor 100, where the hybrid core mentioned in Step 210 can be temporarily kept in the first mode mentioned above.

In another example, the trigger event mentioned in Step 210 may indicate that at least one portion of the processor 100 is idle (e.g. the aforementioned at least one portion of the processor 100 is idle at the moment when the occurrence of the trigger event mentioned in Step 210 is detected). In one example, in Step 220, in a situation where the hybrid core is in the second mode, the processor 100 may perform mode switching of the hybrid core to switch to a turned off mode such as that mentioned above, to turn off the hybrid core. This is for illustrative purposes only, and is not meant to be a limitation of the present invention. According to some embodiments, in a situation where the number of cores within the processor 100 is greater than one, the processor 100 may turn off another core (e.g. another hybrid core or a normal core) within the cores of the processor 100, where the hybrid core mentioned in Step 210 can be temporarily kept in the second mode mentioned above. According to some embodiments, in a situation where the number of cores within the processor 100 is greater than one, the processor 100 may perform mode switching of another core (e.g. another hybrid core) within the processor 100, where the hybrid core mentioned in Step 210 can be temporarily kept in the second mode mentioned above.

Please note that, as the operations of Steps 210 and 220 are illustrated in a loop, the operations of Steps 210 and 220 can be performed with respect to a loop index. In one embodiment, the trigger event mentioned in Step 210 can be changed from one of a plurality of trigger events to another of the plurality of trigger events while the loop index is varying, and therefore the corresponding mode switching performed in Step 220 maybe different while the loop index is varying. For example, when the loop index is equivalent to a specific value, the trigger event mentioned in Step 210 can be one trigger event within the plurality of trigger events, where the mode switching associated with the trigger event of this example can be performed correspondingly. In another example, when the loop index is equivalent to another value (which is different from the specific value mentioned above), the trigger event mentioned in Step 210 can be another trigger event within the plurality of trigger events, where the mode switching associated with the trigger event of this example can be performed correspondingly.

According to some embodiments, the trigger event mentioned in Step 210 may indicate that computing capability of the processor 100 is insufficient. More particularly, in Step 220, in a situation where the hybrid core mentioned in Step 210 is in the turned off mode mentioned above, the processor 100 may perform mode switching of the hybrid core to switch to the first mode, to configure the hybrid core into the first arrangement. This is for illustrative purposes only, and is not meant to be a limitation of the present invention.

According to some embodiments, the trigger event mentioned in Step 210 may indicate that at least one portion of the processor 100 is idle. More particularly, in Step 220, in a situation where the hybrid core is in the first mode mentioned above, the processor 100 may perform mode switching of the hybrid core to switch to the turned off mode mentioned above, to turn off the hybrid core. This is for illustrative purposes only, and is not meant to be a limitation of the present invention.

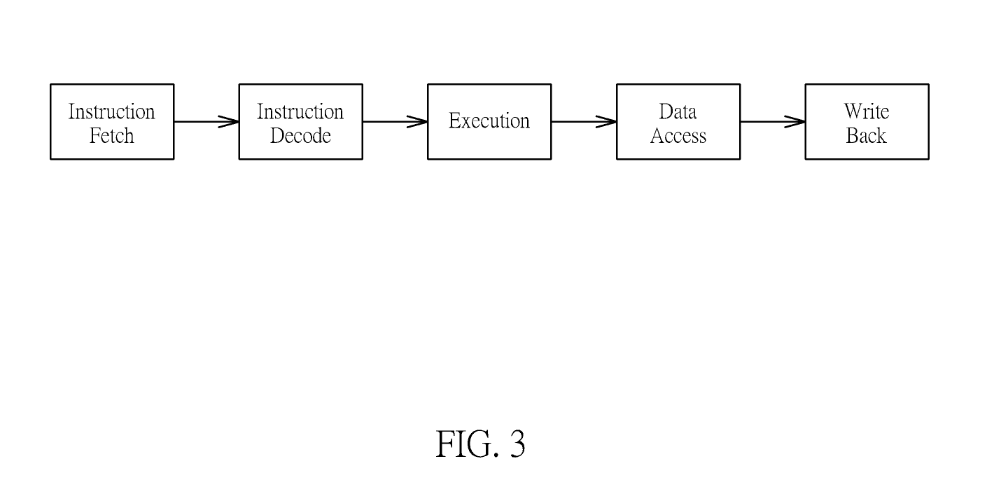

FIG. 3 illustrates a processor pipeline involved with the method 200 shown in FIG. 2 according to an embodiment of the present invention. For example, a core within the processor 100 (e.g. the hybrid core mentioned in Step 220, or a normal core in a situation where the number of cores within the processor 100 is greater than one) may comprise the processor pipeline shown in FIG. 3. This is for illustrative purposes only, and is not meant to be a limitation of the present invention.

As shown in FIG. 3, this processor pipeline may comprise a plurality of processing circuits, where the plurality of processing circuits may comprise an instruction fetch circuit, an instruction decode circuit, an execution circuit, a data access circuit, and a write back circuit (respectively labeled “Instruction Fetch”, “Instruction Decode”, “Execution”, “Data Access”, and “Write Back” in FIG. 3, for brevity). The instruction fetch circuit may be arranged for performing instruction fetching, and therefore can fetch an instruction for this processor pipeline, and the instruction decode circuit may be arranged for performing instruction decoding, and therefore can decode the instruction fetched by the instruction fetch circuit and properly handle the instruction for this processor pipeline. In addition, the execution circuit may be arranged for performing instruction execution, and more particularly, can execute the instruction according to the decoded result obtained from the instruction decode circuit, where the data access circuit can be utilized for accessing data (e.g. reading data and/or writing data) for the execution circuit. Additionally, the write back circuit may be arranged for outputting the execution result for this processor pipeline, and for example, can write back the output data into a storage unit. Please note that the processor pipeline shown in FIG. 3 can be utilized as a basic computing unit in the processor 100 with respect to an instruction such as that mentioned above.

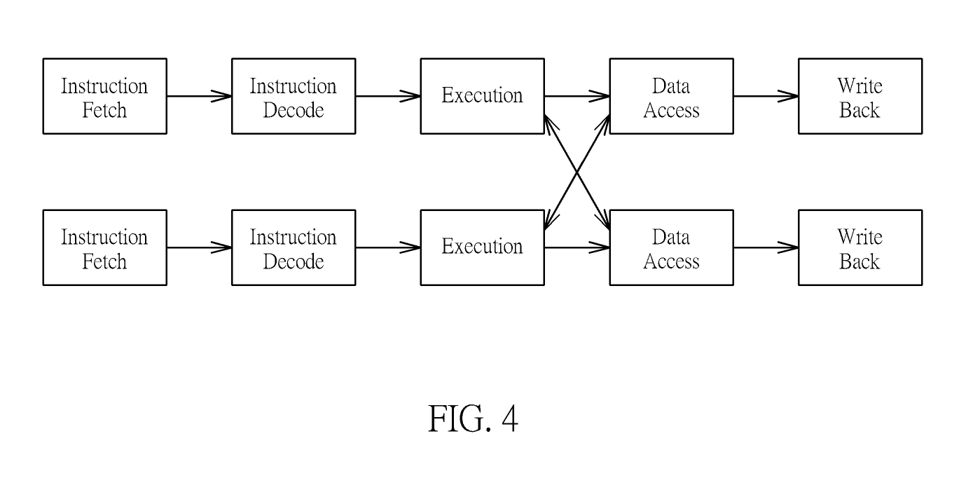

FIG. 4 illustrates some processor pipelines involved with the method 200 shown in FIG. 2 according to an embodiment of the present invention. For example, a core within the processor 100 (e.g. the hybrid core mentioned in Step 220, or a normal core in a situation where the number of cores within the processor 100 is greater than one) may comprise the processor pipelines shown in FIG. 4. This is for illustrative purposes only, and is not meant to be a limitation of the present invention.

As shown in FIG. 4, each of these processor pipelines may comprise a plurality of processing circuits, where the plurality of processing circuits may comprise an instruction fetch circuit, an instruction decode circuit, an execution circuit, a data access circuit, and a write back circuit (respectively labeled “Instruction Fetch”, “Instruction Decode”, “Execution”, “Data Access”, and “Write Back” in FIG. 4, for brevity). Please note that the processor pipelines shown in FIG. 4 can be utilized for performing multiple instructions at the same time. In addition, the computing capability of the processor pipelines shown in FIG. 4 is typically greater than the computing capability of the processor pipeline shown in FIG. 3 since the number of processor pipelines in the architecture shown in FIG. 4 is greater than the number of processor pipelines in the architecture shown in FIG. 3. Additionally, data may be transmitted or exchanged between the processor pipeline shown in the upper half of FIG. 4 and the processor pipeline shown in the lower half of FIG. 4 when needed.

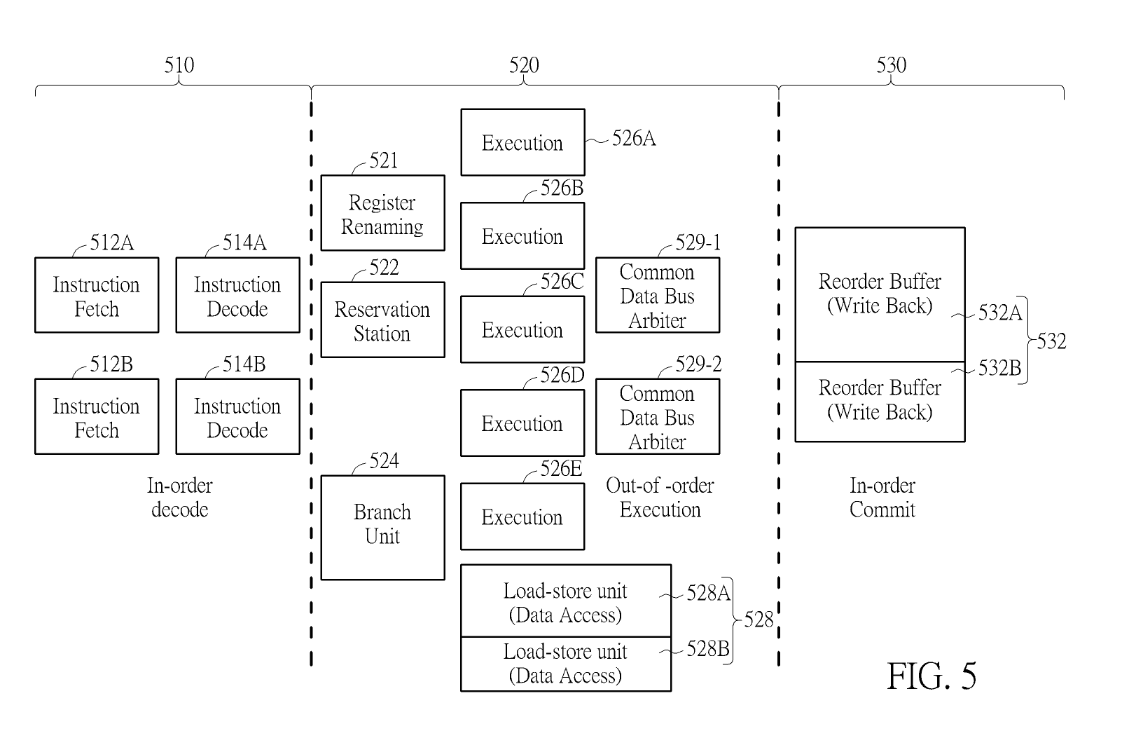

FIG. 5 illustrates some pipeline stages 510, 520, and 530 involved with the method 200 shown in FIG. 2 according to an embodiment of the present invention. For example, a core within the processor 100 (e.g. the hybrid core mentioned in Step 220, or another hybrid core in a situation where the number of cores within the processor 100 is greater than one) may comprise the pipeline stages 510, 520, and 530 shown in FIG. 5. This is for illustrative purposes only, and is not meant to be a limitation of the present invention.

As shown in FIG. 5, the pipeline stage 510 can be an in-order decode pipeline stage (labeled “In-order Decode” in FIG. 5, for brevity) such as that mentioned above, the pipeline stage 520 can be an out-of-order execution pipeline stage (labeled “Out-of-order Execution” in FIG. 5, for brevity) such as that mentioned above, and the pipeline stage 530 can be an in-order commit pipeline stage (labeled “In-order Commit” in FIG. 5, for brevity) such as that mentioned above. In one example, the pipeline stage 510 may comprise multiple instruction fetch circuits 512A and 512B (respectively labeled “Instruction Fetch” in FIG. 5, for brevity), such as the instruction fetch circuits shown in FIG. 4 or multiple copies of the instruction fetch circuit shown in FIG. 3, and may further comprise multiple instruction decode circuits 514A and 514B (respectively labeled “Instruction Decode” in FIG. 5, for brevity), such as the instruction decode circuits shown in FIG. 4 or multiple copies of the instruction decode circuit shown in FIG. 3.

In addition, the pipeline stage 520 may comprise multiple execution circuits 526A, 526B, 526C, 526D, and 526E (respectively labeled “Execution” in FIG. 5, for brevity), such as the execution circuits shown in FIG. 4 or multiple copies of the execution circuit shown in FIG. 3, and may further comprise other processing circuits such as a register renaming circuit 521 (labeled “Register Renaming” in FIG. 5, for brevity), a reservation station circuit 522 (labeled “Reservation Station” in FIG. 5, for brevity), a branch unit 524, a load-store module 528 comprising multiple load-store units 528A and 528B (respectively labeled “Load-store Unit (Data Access)” in FIG. 5, for brevity) , and multiple common data bus arbiters 529-1 and 529-2, where the load-store units 528A and 528B may load and/or store data, and may perform operations that are similar to the operations of the data access circuits shown in FIG. 4 or the operation of the data access circuit shown in FIG. 3, and therefore can be regarded as the data access circuits of the architecture shown in FIG. 5. With aid of the register renaming circuit 521, the reservation station circuit 522, the branch unit 524, the load-store module 528 comprising multiple load-store units 528A and 528B, and the common data bus arbiters 529-1 and 529-2, the pipeline stage 520 is capable of performing out-of-order execution on a plurality of instructions rapidly with ease.

Additionally, the pipeline stage 530 may comprise some processing circuits, such as a reorder buffer module 532 comprising multiple reorder buffer circuits 532A and 532B (labeled “Reorder Buffer (Write Back)” in FIG. 5, for brevity), where the reorder buffer circuits 532A and 532B are arranged for outputting the execution results of the pipeline stage 520 for multiple processor pipelines composed of at least one portion (e.g. a portion or all) of the processing units shown in FIG. 5 (e.g. at least one portion of components of the pipeline stages 510, 520, and 530), and for example, can properly write back the output data into a storage unit such as that mentioned above in a correct order, and therefore can be regarded as the write back circuits of the architecture shown in FIG. 5.

Please note that the processor pipelines formed with the aforementioned at least one portion of the processing units shown in FIG. 5 can be utilized for performing multiple instructions at the same time. In addition, the computing capability of the processor pipelines of the embodiment shown in FIG. 5 is typically greater than the computing capability of the processor pipelines shown in FIG. 4 since the number of execution circuits in the architecture shown in FIG. 5 is greater than the number of execution circuits in the architecture shown in FIG. 4. Additionally, data may be transmitted or exchanged between different processor pipelines of the architecture shown FIG. 5 when needed.

In practice, the processor 100 may turn off at least one portion (e.g. a portion or all) of the processing units shown in FIG. 5 (e.g. at least one portion of components of the pipeline stages 510, 520, and 530) when needed. For example, in a situation where the hybrid core mentioned in Step 220 comprises the pipeline stages 510, 520, and 530 shown in FIG. 5, the first core 110 may comprise all of the processing units shown in FIG. 5, while the second core 120 may comprise a portion of the processing units shown in FIG. 5, such as the portion of circuits that the first core 110 corresponding to the first arrangement shares with the second core corresponding to the second arrangement. Then the processor 100 may turn off the non-shared portion of circuits of the first core 110 (i.e. the portion that is not shared with the second core 120) when the hybrid core acts as the second core. In one example, the shared portion of circuits of the first core 110 corresponding to the first arrangement may comprise the instruction fetch circuit 512A, the instruction decode circuit 514A, the execution circuit 526A, the load-store unit 528A, and the reorder buffer circuit 532A. For brevity, similar descriptions for this embodiment are not repeated in detail here.

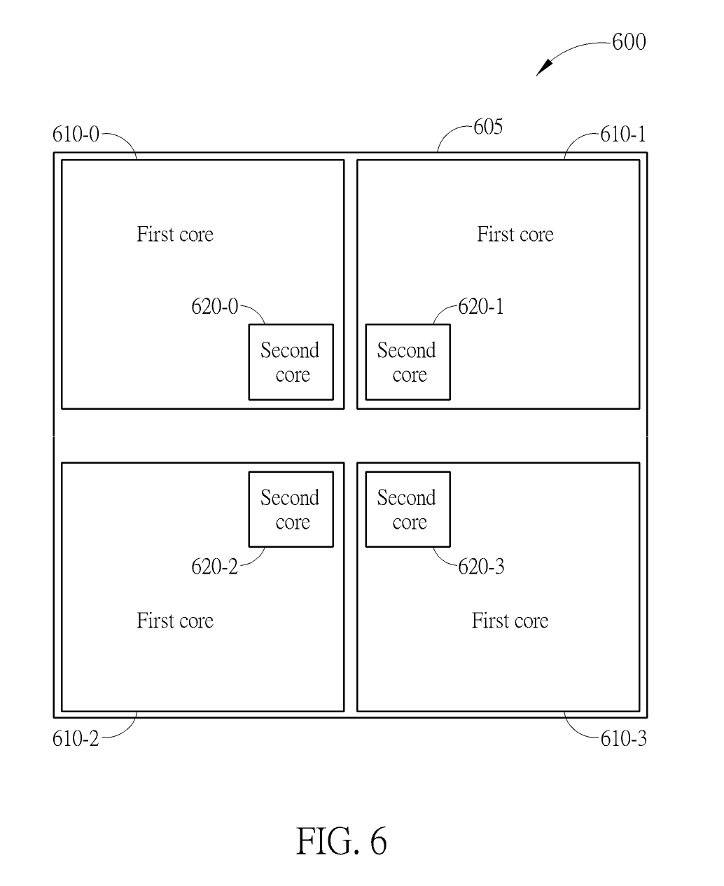

FIG. 6 is a diagram of a processor 600 equipped with a hybrid core architecture such as that mentioned above according to another embodiment of the present invention, where there are four hybrid cores in the cluster 605 shown in FIG. 6. In one example, each of the hybrid cores in the cluster 605 shown in FIG. 6 can be a copy of the hybrid core 105 shown in FIG. 1. For example, the first core 610-0 shown in FIG. 6 can be a copy of the first core 110 in the hybrid core 105, and the second core 620-0 shown in FIG. 6 can be a copy of the second core 120 in the hybrid core 105. In another example, the first core 610-1 shown in FIG. 6 can be a copy of the first core 110 in the hybrid core 105, and the second core 620-1 shown in FIG. 6 can be a copy of the second core 120 in the hybrid core 105. In another example, the first core 610-2 shown in FIG. 6 can be a copy of the first core 110 in the hybrid core 105, and the second core 620-2 shown in FIG. 6 can be a copy of the second core 120 in the hybrid core 105. In another example, the first core 610-3 shown in FIG. 6 can be a copy of the first core 110 in the hybrid core 105, and the second core 620-3 shown in FIG. 6 can be a copy of the second core 120 in the hybrid core 105.

According to this embodiment, one hybrid core in the processor 600 (such as the hybrid core mentioned in the embodiment shown in FIG. 1, the hybrid core mentioned in Step 220, or any hybrid core within the plurality of hybrid cores mentioned above) can be configured to be any of two or more pre-defined cores, such as a big core or a small core in this embodiment. Thus, there may be various combinations of hybrid core configurations of the processor 600, where at least one portion (e.g. a portion or all) of one hybrid core in the processor 600 can be temporarily turned off or turned on when needed, no matter whether at least one portion (e.g. a portion or all) of another hybrid core in the processor 600 is currently turned off or turned on. Examples of the aforementioned various combinations of hybrid core configurations of the processor 600 may include, but not limited to, the following combinations:

1. One small core (e.g. any one of the four hybrid cores in the processor 600 can be configured into the second core thereof, where the other hybrid cores in the processor 600 can be temporarily turned off);
2. Two small cores (e.g. any two of the four hybrid cores in the processor 600 can be configured into the second cores thereof, respectively, where the other hybrid cores can be temporarily turned off);
3. Three small cores (e.g. any three of the four hybrid cores in the processor 600 can be configured into the second cores thereof, respectively, where the other hybrid core can be temporarily turned off);
4. Four small cores (e.g. all of the four hybrid cores in the processor 600 can be configured into the second cores thereof, respectively);
5. One big core (e.g. any one of the four hybrid cores in the processor 600 can be configured into the first core thereof, where the other hybrid cores can be temporarily turned off);
6. Two big cores (e.g. any two of the four hybrid cores in the processor 600 can be configured into the first cores thereof, respectively, where the other hybrid cores can be temporarily turned off);
7. Three big cores (e.g. any three of the four hybrid cores in the processor 600 can be configured into the first cores thereof, respectively, where the other hybrid core can be temporarily turned off);
8. Four big cores (e.g. all of the four hybrid cores in the processor 600 can be configured into the first cores thereof, respectively);
9. One big core plus one or more small cores (e.g. any one of the four hybrid cores in the processor 600 can be configured into the first core thereof, and at least one of the other hybrid cores can be configured into the second core thereof, where any remaining hybrid core, if exists, can be temporarily turned off);
10. Two big cores plus one or two small cores (e.g. any two of the four hybrid cores in the processor 600 can be configured into the first cores thereof, respectively, and at least one of the other hybrid cores can be configured into the second core thereof, where any remaining hybrid core, if exists, can be temporarily turned off);
11. Three big cores plus one small core (e.g. any three of the four hybrid cores in the processor 600 can be configured into the first cores thereof, respectively, and the other hybrid core can be configured into the second core thereof); and
12. No core (e.g. all of the four hybrid cores in the processor 600 can be temporarily turned off).
For brevity, similar descriptions for this embodiment are not repeated in detail here.

By implementing according to one or more embodiments of the present invention, a same cluster may own heterogeneous cores, so it is unnecessary to use a snooping channel for maintaining coherence, where the snooping channel is typically used for snooping between different clusters. As a result, when performing mode switching, only flushing the internal pipeline is needed. Therefore, in comparison with the related art, the present invention processor such as the processor 600 or the processor 100 can reduce penalty of code migration between different modes, and can easily perform mode switching by just flushing the internal pipeline thereof and then switching to a target mode (e.g. the first mode, or the second mode), and can further provide more various combinations of hybrid core configurations, such as the aforementioned various combinations of hybrid core configurations of the processor 600 in the embodiment shown in FIG. 6 or the various combinations of hybrid core configurations of the processor 100 in some embodiments described between the embodiment shown in FIG. 1 and the embodiment shown in FIG. 2. For example, in a situation where the chip area is the same as that of the related art, the number of combinations of the hybrid core configurations of the present invention processor (e.g. the processor 600 or the processor 100) is typically greater than the number of combinations of the conventional cores implemented according to the related art.

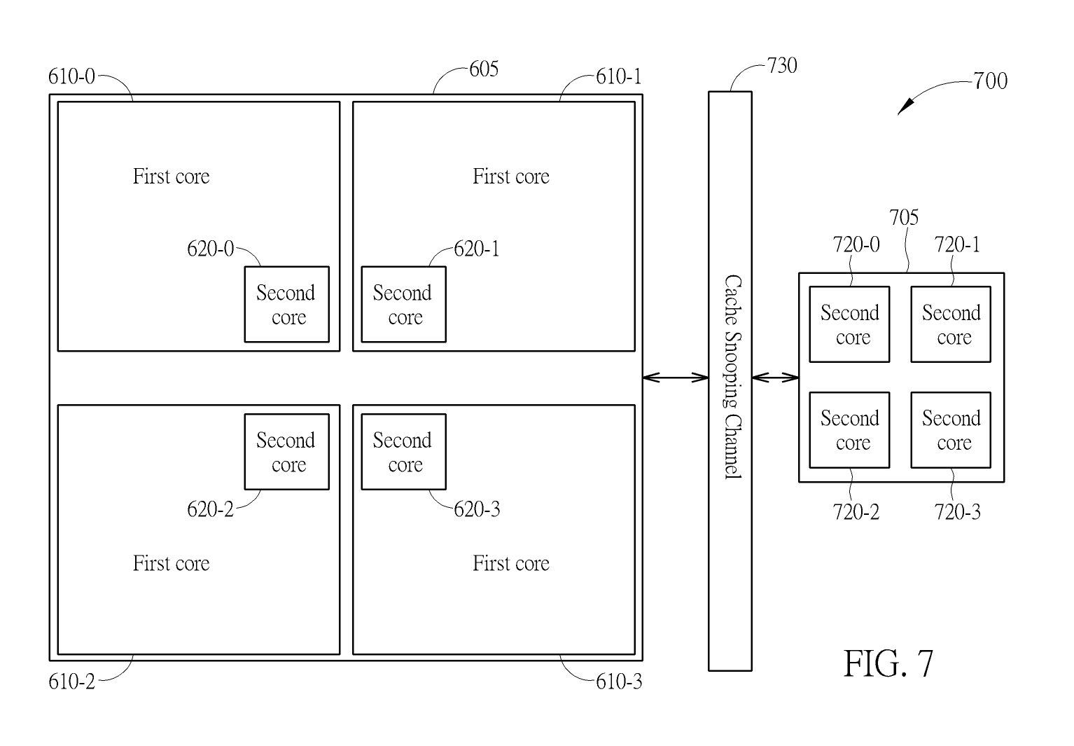

FIG. 7 is a diagram of a processor 700 equipped with a hybrid core architecture such as that mentioned above according to another embodiment of the present invention, where there are four hybrid cores in the cluster 605 shown in the left half of FIG. 7. In one example, the four hybrid cores in the cluster 605 shown in the left half of FIG. 7 can be the same as the four hybrid cores in the cluster 605 shown FIG. 6. In addition, the processor 700 may comprise another cluster 705 and a cache snooping channel 730 (e.g. the so-called Cache Coherent Interconnect (CCI) such as the aforementioned CCI-400), where the cluster 705 may comprise multiple cores such as four cores 720-0, 720-1, 720-2, and 720-3. In one example, the four cores 720-0, 720-1, 720-2, and 720-3 in the cluster 705 shown in the right half of FIG. 7 may have the same size as that of the second cores 620-0, 620-1, 620-2, and 620-3 in the cluster 605 shown in the left half of FIG. 7, respectively, and therefore can be referred to as the second cores in this embodiment, respectively. For example, the four cores 720-0, 720-1, 720-2, and 720-3 may have almost the same computing capability as that of the second cores 620-0, 620-1, 620-2, and 620-3 in this embodiment, respectively. In practice, the cache snooping channel 730 may be arranged for performing cache snooping for one or more clusters within the cluster 605 and 705. As a result, any processor core in one cluster within the cluster 605 and 705 can be aware of the contents in the cache of the other cluster within the cluster 605 and 705, and therefore the processor 700 can perform operations fluently by utilizing both of the cluster 605 and 705 when needed.

According to this embodiment, one hybrid core in the cluster 605 (such as the hybrid core mentioned in the embodiment shown in FIG. 1, the hybrid core mentioned in Step 220, or any hybrid core within the plurality of hybrid cores mentioned above) can be configured to be any core within two or more pre-defined cores, such as a big core or a small core in this embodiment. Thus, there may be various combinations of hybrid core configurations of the cluster 605, where at least one portion (e.g. a portion or all) of one hybrid core in the cluster 605 can be temporarily turned off or turned on when needed, no matter whether at least one portion (e.g. a portion or all) of another hybrid core in the cluster 605 is currently turned off or turned on. Examples of the aforementioned various combinations of hybrid core configurations of the cluster 605 may include, but not limited to, those listed in the embodiment shown in FIG. 6. For brevity, similar descriptions for this embodiment are not repeated in detail here.

Please note that the aforementioned various combinations of hybrid core configurations of the cluster 605 can be utilized arbitrarily when needed, no matter whether at least one portion (e.g. a portion or all) of the cluster 705 is turned on or turned off, where there are various combinations of core configurations of the cluster 705. Thus, the processor 700 can provide more combinations by mixing the aforementioned various combinations of hybrid core configurations of the cluster 605 and the various combinations of core configurations of the cluster 705. Examples of the aforementioned various combinations of core configurations of the cluster 705 may include, but not limited to, the following combinations:

1. One small core (e.g. any one of the four cores in the cluster 705 can be temporarily turned on, where the other cores can be temporarily turned off);
2. Two small cores (e.g. any two of the four cores in the cluster 705 can be temporarily turned on, respectively, where the other cores can be temporarily turned off);
3. Three small cores (e.g. any three of the four cores in the cluster 705 can be temporarily turned on, respectively, where the other core can be temporarily turned off);
4. Four small cores (e.g. all of the four cores in the cluster 705 can be temporarily turned on, respectively); and
5. No core (e.g. all of the four cores in the cluster 705 can be temporarily turned off).
As a result, the processor 700 can provide a lot of combinations by mixing the aforementioned various combinations of hybrid core configurations of the cluster 605 and the aforementioned various combinations of core configurations of the cluster 705. For brevity, similar descriptions for this embodiment are not repeated in detail here.

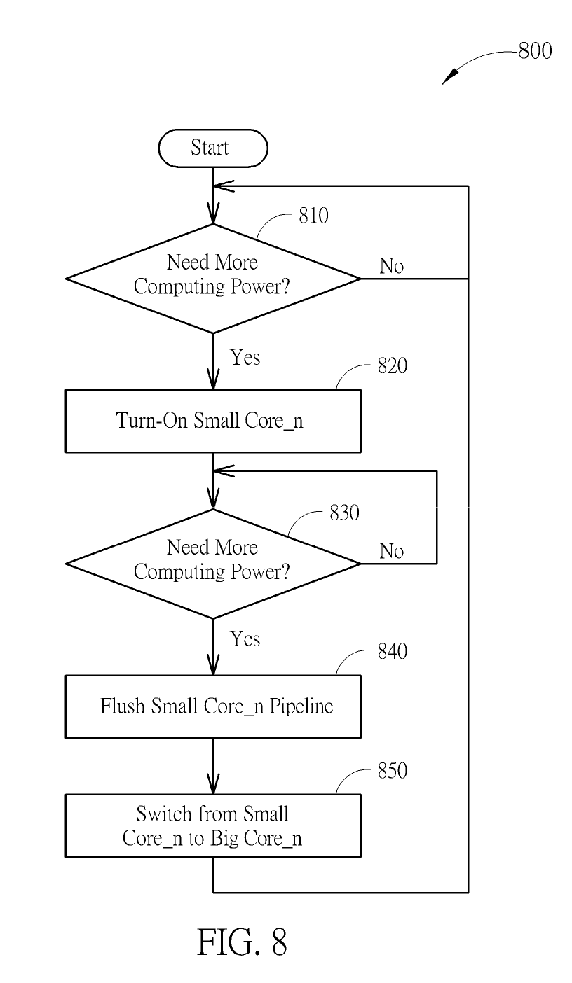

FIG. 8 illustrates a working flow 800 involved with the method 200 shown in FIG. 2 according to an embodiment of the present invention. For example, the trigger event mentioned in Step 210 may indicate that the computing capability of the processor (e.g. the processor 100, the processor 600, or the processor 700) in any embodiment described above is insufficient. For example, the computing capability of this processor may be insufficient at the moment when the occurrence of the trigger event mentioned in Step 210 is detected. According to this embodiment, the working flow 800 shown in FIG. 8 can be utilized for increasing the computing capability of this processor and enhancing the performance thereof.

In Step 810, the processor (e.g. the processor 100, the processor 600, or the processor 700) may check whether it needs more computing power (or computing capability). When it is detected that this processor needs more computing power (or computing capability), Step 820 is entered; otherwise, Step 810 is re-entered.

In Step 820, this processor may turn on a small core_n, where the notation n may represent a loop index of the loop comprising Step 810, Step 820, Step 830, Step 840, and Step 850 within the working flow 800 shown in FIG. 8. Please note that the aforementioned small core_n in Step 820 can be a hybrid core core_n that is configured into the second arrangement in the second mode of the hybrid core core_n. According to this embodiment, the hybrid core core_n can be taken as an example of the hybrid core mentioned in Step 220.

In one example, the loop index n can be any integer that falls within the range of the interval [0, 3] in a situation where there are at least four hybrid cores within this processor. For example, this processor can be the processor 600 shown in FIG. 6, and the hybrid core core_n may represent the corresponding hybrid core in the processor 600, and therefore the aforementioned small core_n (e.g. the small core_0, the small core_1, the small core_2, or the small core_3) may represent the corresponding second core 620-n in the processor 600 (e.g. the second core 620-0, the second core 620-1, the second core 620-2, or the second core 620-3, respectively). In another example, this processor can be the processor 700 shown in FIG. 7, and the hybrid core core_n may represent the corresponding hybrid core in the cluster 605 thereof, and therefore the aforementioned small core_n (e.g. the small core_0, the small core_1, the small core_2, or the small core_3) may represent the corresponding second core 620-n in the cluster 605 (e.g. the second core 620-0, the second core 620-1, the second core 620-2, or the second core 620-3, respectively).

In Step 830, this processor may check whether it needs more computing power (or computing capability). When it is detected that this processor needs more computing power (or computing capability), Step 840 is entered; otherwise, Step 830 is re-entered.

In Step 840, this processor may flush the small core_n pipeline (i.e. the pipeline of the aforementioned small core_n in Step 820). As a result, data loss or some other problems can be prevented during mode switching.

In Step 850, this processor switches from the small core_n to a big core_n. Please note that the big core_n can be the hybrid core core_n that is configured into the first arrangement in the first mode of the hybrid core core_n. According to this embodiment, the hybrid core core_n can be taken as an example of the hybrid core mentioned in Step 220.

In one example, the loop index n can be any integer that falls within the range of the interval [0, 3] in a situation where there are at least four hybrid cores within this processor. For example, this processor can be the processor 600 shown in FIG. 6, and the hybrid core core_n may represent the corresponding hybrid core in the processor 600, and therefore the aforementioned big core_n (e.g. the big core_0, the big core_1, the big core_2, or the big core_3) may represent the corresponding first core 610-n in the processor 600 (e.g. the first core 610-0, the first core 610-1, the first core 610-2, or the first core 610-3, respectively). In another example, this processor can be the processor 700 shown in FIG. 7, and the hybrid core core_n may represent the corresponding hybrid core in the cluster 605 thereof, and therefore the aforementioned big core_n (e.g. the big core_0, the big core_1, the big core_2, or the big core_3) may represent the corresponding first core 610-n in the cluster 605 (e.g. the first core 610-0, the first core 610-1, the first core 610-2, or the first core 610-3, respectively).

According to this embodiment, the working flow 800 shown in FIG. 8 may comprise one or more other steps to control the loop index n and the associated loop control. For example, the loop index n can be increased with an increment of one after the operation of Step 850 is performed, where the initial value of the loop index n can be set as zero for the loop comprising Step 810, Step 820, Step 830, Step 840, and Step 850. In addition, the working flow 800 shown in FIG. 8 may come to the end in a situation where a temporary value of the loop index n reaches a predetermined threshold. For example, when the temporary value of the loop index n falls outside the range of the interval [0, 3], the working flow 800 shown in FIG. 8 may come to the end. For brevity, similar descriptions for this embodiment are not repeated in detail here.

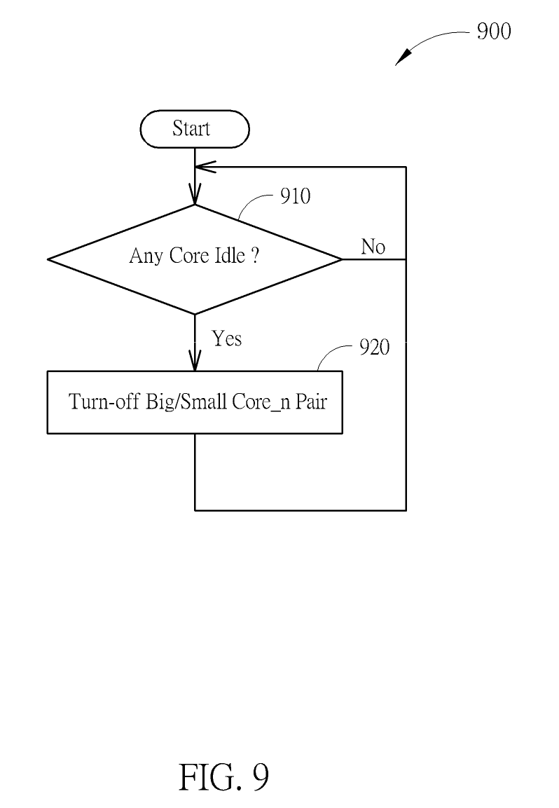

FIG. 9 illustrates a working flow 900 involved with the method 200 shown in FIG. 2 according to another embodiment of the present invention. For example, the trigger event mentioned in Step 210 may indicate that at least one portion of the processor (e.g. the processor 100, the processor 600, or the processor 700) in any embodiment described above is idle. For example, the aforementioned at least one portion of this processor (e.g. the processor 100, the processor 600, or the processor 700) maybe idle at the moment when the occurrence of the trigger event mentioned in Step 210 is detected. According to this embodiment, the working flow 900 shown in FIG. 9 can be utilized for saving power of this processor .

In Step 910, the processor may check whether any core is idle. When it is detected that a core in this processor, such as the aforementioned hybrid core core_n, is idle, Step 920 is entered; otherwise, Step 910 is re-entered.

In Step 920, this processor may turn off the idle core such as the aforementioned hybrid core core_n (labeled “Big/Small Core_n Pair” in FIG. 9, for better comprehension, since the aforementioned hybrid core core_n may comprise the big core_n mentioned above and may comprise the small core_n mentioned above).

Please note that the index value of n in “Big/Small Core_n Pair” in Step 920 is not controlled to be a loop index in the working flow 900, since the specific core such as the aforementioned hybrid core core_n should be determined independently every time when the operation of Step 910 is performed. For brevity, similar descriptions for this embodiment are not repeated in detail here.

Please note that, in different embodiments, the steps shown in FIGS. 2, 8 and 9 may be performed in different order, and one or more steps maybe removed from and/or added to the flow shown in FIGS. 2, 8 and 9. In addition, although the hybrid core in any of the embodiments shown in FIGS. 1, 6 and 7 may be configurable into two different arrangements, the hybrid core maybe configurable into more than two arrangements in different modes of the hybrid core, respectively, in some embodiments. For example, a hybrid core may be configurable into three arrangements in different modes of this hybrid core, respectively. Additionally, although the hybrid core architecture in the embodiment shown in FIG. 6 may be similar to at least a portion of the hybrid core architecture in the embodiment shown in FIG. 7, please note that the hybrid core architecture may vary in some embodiments or may be similar in some embodiments . Further, different modes or different arrangements in any of the above embodiments may represent that characteristics respectively corresponding to the different modes or corresponding to the different arrangements are different, where examples of these characteristics may include, but not limited to, the performance, the power consumption, the manner of instruction execution (e.g. out of order, in order) , the chip area, the working frequency, the working voltage, the heat generation rate, the number of pipeline stages, and any combination thereof.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A processor, comprising:
a hybrid core that is configurable into different arrangements in different modes of the hybrid core, respectively, the different arrangements comprising:
a first arrangement, wherein the first arrangement in a first mode of the hybrid core causes the hybrid core to act as a first core, and the first core corresponding to the first arrangement is arranged for reading and executing program instructions for the processor; and
a second arrangement, wherein the second arrangement in a second mode of the hybrid core causes the hybrid core to act as a second core, and the second core corresponding to the second arrangement is arranged for reading and executing program instructions for the processor;
wherein the second core corresponding to the second arrangement shares a portion of circuits of the first core corresponding to the first arrangement.

2. The processor of claim 1, wherein the first core corresponding to the first arrangement comprises a plurality of pipeline stages;
and the second core corresponding to the second arrangement shares at least one processing circuit in a pipeline stage within the plurality of pipeline stages of the first core corresponding to the first arrangement.

3. The processor of claim 1, wherein the first core corresponding to the first arrangement comprises a plurality of pipeline stages;
a specific pipeline stage within the plurality of pipeline stages comprises a plurality of processing circuits arranged for performing processing in parallel for the first core corresponding to the first arrangement; and the second core corresponding to the second arrangement shares a specific processing circuit within the plurality of processing circuits.

4. The processor of claim 3, wherein the specific pipeline stage is an out-of-order execution pipeline stage within the first core corresponding to the first arrangement; and the specific processing circuit becomes a processing circuit of an in-order execution pipeline stage within the second core corresponding to the second arrangement when the hybrid core acts as the second core.

5. The processor of claim 4, wherein another pipeline stage within the plurality of pipeline stages comprises a plurality of other processing circuits; and the second core corresponding to the second arrangement shares at least one processing circuit within the plurality of other processing circuits.

6. The processor of claim 5, wherein the other pipeline stage is an in-order decode pipeline stage within the first core corresponding to the first arrangement; and the at least one processing circuit within the plurality of other processing circuits becomes at least one processing circuit of an in-order decode pipeline stage within the second core corresponding to the second arrangement when the hybrid core acts as the second core.

7. The processor of claim 6, wherein the plurality of other processing circuits comprises a plurality of instruction fetch circuits.

8. The processor of claim 6, wherein the plurality of other processing circuits comprises a plurality of instruction decode circuits.

9. The processor of claim 5, wherein the other pipeline stage is an in-order commit pipeline stage within the first core corresponding to the first arrangement; and the at least one processing circuit within the plurality of other processing circuits becomes at least one processing circuit of an in-order commit pipeline stage within the second core corresponding to the second arrangement when the hybrid core acts as the second core.

10. The processor of claim 1, wherein a whole of the second core corresponding to the second arrangement is within the first core corresponding to the first arrangement.

11. The processor of claim 1, wherein the portion of circuits of the first core corresponding to the first arrangement is turned on in each mode of the first mode and the second mode.

12. The processor of claim 11, wherein another portion of circuits of the first core corresponding to the first arrangement is turned off in the second mode. 13 . The processor of claim 12, wherein both of the portion of circuits of the first core corresponding to the first arrangement and the other portion of circuits of the first core corresponding to the first arrangement are turned on in the first mode.

14. The processor of claim 1, wherein the processor comprises a central processing unit (CPU), a graphics processing unit (GPU) or a combination thereof.

15. The processor of claim 1, wherein the processor comprises a plurality of hybrid cores, and the hybrid core is a specific hybrid core within the plurality of hybrid cores; and another hybrid core within the plurality of hybrid cores is configurable into different arrangements in different modes.

16. The processor of claim 15, wherein any two hybrid cores within the plurality of hybrid cores are equivalent to each other.

17. The processor of claim 15, wherein the different arrangements of the other hybrid core comprises:
a third arrangement, wherein the third arrangement in a third mode of the other hybrid core causes the other hybrid core to act as a third core, and the third core corresponding to the third arrangement is arranged for reading and executing program instructions for the processor; and
a fourth arrangement, wherein the fourth arrangement in a fourth mode of the other hybrid core causes the other hybrid core to act as a fourth core, and the fourth core corresponding to the fourth arrangement is arranged for reading and executing program instructions for the processor;
wherein the fourth core corresponding to the fourth arrangement shares a portion of circuits of the third core corresponding to the third arrangement.

18. A method for performing operational mode control on a processor, the method comprising the steps of:
detecting whether a trigger event occurs to generate a detecting result, for controlling a hybrid core of the processor, wherein the hybrid core is configurable into different arrangements in different modes of the hybrid core, respectively, and the different arrangements of the hybrid core comprises:
a first arrangement, wherein the first arrangement in a first mode of the hybrid core causes the hybrid core to act as a first core, and the first core corresponding to the first arrangement is arranged for reading and executing program instructions for the processor; and
a second arrangement, wherein the second arrangement in a second mode of the hybrid core causes the hybrid core to act as a second core, and the second core corresponding to the second arrangement is arranged for reading and executing program instructions for the processor;
wherein the second core corresponding to the second arrangement shares a portion of circuits of the first core corresponding to the first arrangement; and
according to the detecting result, performing mode switching of the hybrid core to configure the hybrid core into a specific arrangement within the different arrangements.

19. The method of claim 18, wherein the trigger event indicates that computing capability of the processor is insufficient; and the step of performing mode switching of the hybrid core to configure the hybrid core into the specific arrangement within the different arrangements further comprises:
in a situation where the hybrid core is in the second mode, performing mode switching of the hybrid core to switch to the first mode, to configure the hybrid core into the first arrangement.

20. The method of claim 18, wherein the trigger event indicates that computing capability of the processor is insufficient; and the step of performing mode switching of the hybrid core to configure the hybrid core into the specific arrangement within the different arrangements further comprises:
in a situation where the hybrid core is in a turned off mode, performing mode switching of the hybrid core to switch to the second mode, to configure the hybrid core into the second arrangement.

21. The method of claim 18, wherein the trigger event indicates that at least one portion of the processor is idle; and the step of performing mode switching of the hybrid core to configure the hybrid core into the specific arrangement within the different arrangements further comprises:
in a situation where the hybrid core is in the first mode, performing mode switching of the hybrid core to switch to the second mode, to configure the hybrid core into the second arrangement.

22. The method of claim 18, wherein the trigger event indicates that at least one portion of the processor is idle; and the step of performing mode switching of the hybrid core to configure the hybrid core into the specific arrangement within the different arrangements further comprises:
in a situation where the hybrid core is in the second mode, performing mode switching of the hybrid core to switch to a turned off mode, to turn off the hybrid core.
